(19) United States
(12) Patent Application Publication
(10) Pub. No.: US 2002/0083816 A1
(43) Pub. Date: Jul. 4, 2002

(54) Cutting machine for cutting up foodstuffs

(75) Inventor: Dieter Krauss, Markt Rettenbach (DE)

Correspondence Address: JACOBSON HOLMAN PLLC, 400 SEVENTH STREET N.W., SUITE 600, WASHINGTON, DC, 20004, US

(73) Assignee: Dixie-Union GmbH & Co. KG

(21) Appl. No.: 10/059,336

(22) Filed: Jan. 31, 2002

Related U.S. Application Data
(62) Division of application No. 09/460,436, filed on Dec. 14, 1999.

(30) Foreign Application Priority Data
Dec. 14, 1998 (DE) 298 22 282.5

(51) Int. Cl. B26D 7/06

(52) U.S. Cl. 83/932; 83/753; 83/409; 83/422; 83/437.2

(57) ABSTRACT

The invention relates to a cutting machine for cutting up foodstuffs, particularly sausage, ham, bacon, meat, cheese and the like, with a cutting head disposed on a base frame (8) as well as a product delivery unit with a guide (7) for the product to be cut and a feed arrangement, wherein at the cutting end of the product (6) to be cut a holder (1) is provided which fixes and shapes the foodstuff (6) and which can be retracted from the blade (11) with the guide (7) for the product to be cut in order to prevent the formation of slivers with idle strokes.

### BACKGROUND OF THE INVENTION

The invention relates to a cutting machine for cutting up foodstuffs, particularly sausage, ham, bacon, meat, cheese and the like, with a cutting head disposed on a base frame as well as a product delivery unit with a guide for the product to be cut and a feed arrangement.

Cutting machines for cutting up foodstuffs are already known in many variants. In these, one or more pieces of product to be cut is/are placed on a product delivery unit, pressed with a certain contact pressure against the cutting blade and cut into slices. The essential point here is that the slices should have a uniform thickness and that in the case of idle strokes which are necessary for portioning of the slices the formation of slivers should be avoided.

In order to achieve this, it is already known from the prior art to cool the foodstuff to the extent that it can no longer be deformed on the cutting surface by the contact pressure produced there, or the pieces of food are guided by sleeves which prevent the relatively soft mass from being deformed on the cutting plane.

This is described in particular in DE 39 26 588, in which the feeding force acting in the axial direction on the sausages compresses the pieces of food and an elastic sleeve opposes the resulting, radially outwardly directed pressing force by a radially inwardly directed force, so that deflection of the food product beyond a predeterminable limit is precluded. If a maximum radial pressure is reached, the axial pressure serves exclusively to transport the sausage further without deforming it further.

In this device for cutting foodstuffs provision is not made for portioning of the slices of sausage in that the cutting blade carries out idle strokes and has to be re-started to carry out portioning again during cutting. In this case with such a device a uniform slice thickness would also not be guaranteed, since due to the continuous axial pressure on the food product the first slice of sausage in each case would be thicker and by retraction of the piece of food through the fixing claws the desired effect of maintaining a continuous radial maximum pressure on the cutting plane is also destroyed. EP 289 765 describes how the product to be cut is retracted from the cutting plane in order to generate the idle strokes.

### BRIEF SUMMARY OF THE INVENTION

It is an object of the invention to provide an improved cutting machine for foodstuffs to prevent the formation of slivers with idle strokes.

This and other objects are achieved by a cutting machine for cutting up foodstuffs, particularly sausage, ham, bacon, meat, cheese and the like, with a cutting head disposed on a base frame as well as a product delivery unit with a guide for the product to be cut and a feed arrangement, wherein at the cutting end of the product to be cut a holder is provided which fixes and shapes the foodstuff and which can be retracted from the blade with the guide for the product to be cut in order to prevent the formation of slivers with idle strokes.

This holder is for example firmly connected to the guide for the product to be cut so that during the retracting movement for the idle strokes it also retracts. Thus, it is connected to the other equipment of the cutting machine. The foodstuff can be held at its end remote from the cutting plane by a claw which during feeding fixes the foodstuff in the direction of the cutting plane and during the retracting movement of the guide for the product to be cut together with the holder it carries out an additional retracting movement in order to relieve the food product of the axial pressure. Thus, during the idle strokes, no feeding movement is exerted on the product to be cut.

For driving the holder a leverage is provided which acts on both sides. The holder is provided on both sides with two fixing openings which are disposed one above the other and serve for communication with the guide for the product to be cut. The guide for the product to be cut has a slide bar on each side and the appertaining guide is provided on the machine housing. A bent lever or two-armed lever which is articulated on a driving lever is disposed on each side on the slide. Each driving lever is driven by an eccentric. A motor, which is not described in greater detail, acts on the eccentric. At the moment of retraction of the holder the drive motor turns the eccentric shaft, the lever acts on the bent lever to push it so that the guide for the product to be cut can carry out a reciprocating movement, the holder which is firmly connected to it being entrained.

In the construction according to the invention the holder which fixes and shapes the foodstuff consists in particular of a sleeve made from elastic plastics material and advantageously has at least one funnel-shaped opening into which the foodstuff can be introduced with an accurate fit. The sleeve completely surrounds the periphery of the product to be cut. However, it is desirable that the product to be cut can be deflected to a certain extent in the radial direction or that there should be slight unevenness on the product without it sticking in the sleeve. According to the invention, the elasticity of the material of the sleeve is exploited in order to achieve the contact pressure. This is achieved by the provision of undercuts in a circle around the sleeve opening, and through these the remaining flanges act resiliently. It is possible to connect the undercuts to the opening, so that the flanges lie like resilient tabs on the product to be cut or they have no connection to the opening, so that there is less resilience. The sleeve is advantageously rigid in the feeding direction.

The holder does not have to be a closed sleeve which surrounds the entire product. It is sufficient if jaws act on the product only at several points. For the pressing force two arrangements can be provided—on the one hand a resilient pressing device and on the other hand the pressing of the various parts of the holder can also be achieved by a pressure cylinder, particularly an oval cylinder.

This construction of the holder can be used not only when it is moved together with the usual retracting movements during the idle strokes but also when only the foodstuff is retracted or also when no retracting movement is provided. It is also possible to move the cutting blade away from the product to be cut.

In general, these holders are preferably constructed so that two pieces of food, particularly pieces of sausage or cheese, lying side by side can be cut simultaneously. However, the advantages of such holders are also effective in the case of only one piece of food or also in the case of more than two pieces of food.

### BRIEF DESCRIPTION OF THE DRAWINGS

FIG. 1 shows a top view of a one-part holder;

FIG. 2 shows a sectional side view of the holder according to FIG. 1;

FIG. 3 shows a top view of a two-part holder;

FIG. 4 shows a sectional side view of the holder according to FIG. 2;

FIG. 5 shows a diagrammatic representation of the cutting machine according to the invention.

### DETAILED DESCRIPTION OF PREFERRED EMBODIMENTS

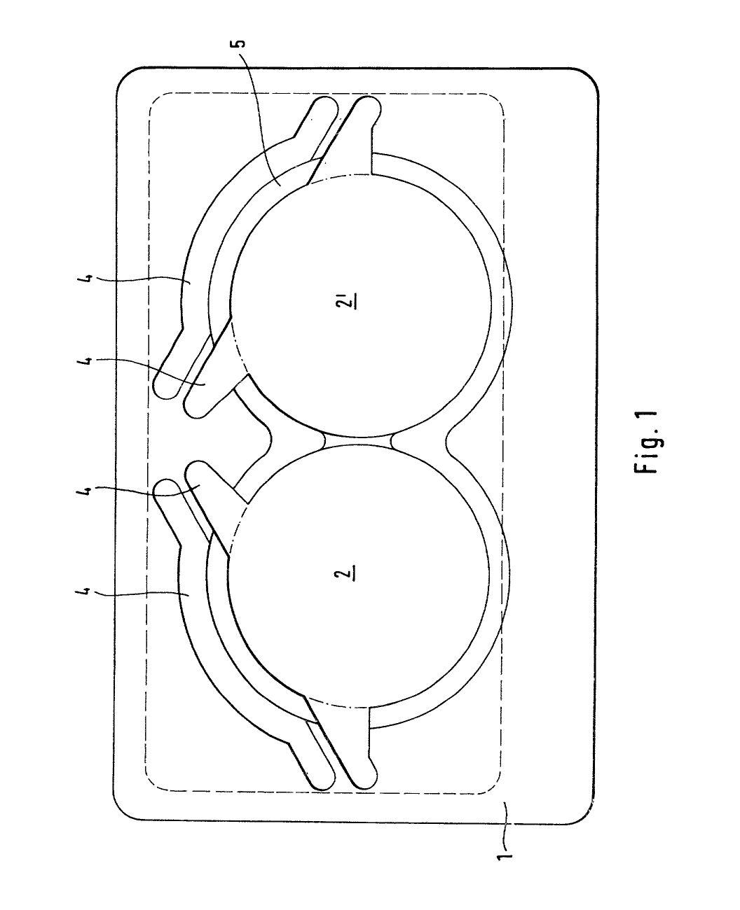

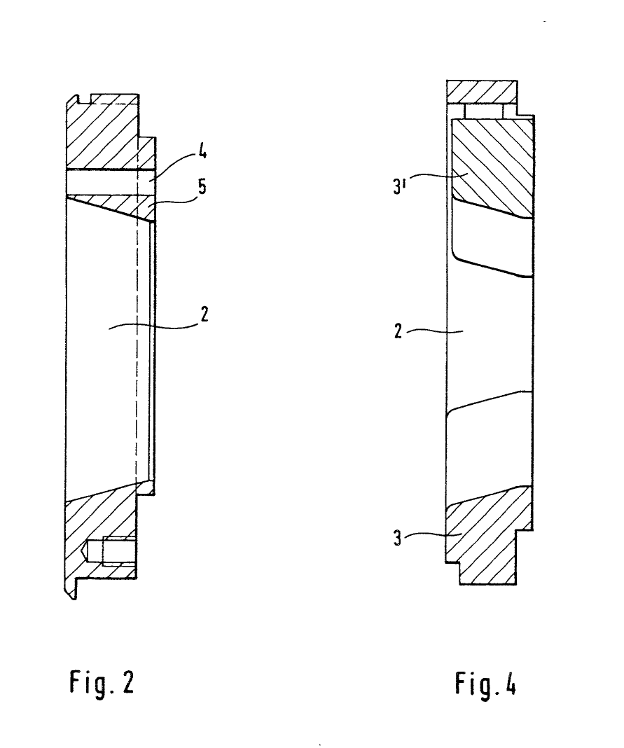

FIG. 1 shows a construction of the holder 1 according to the invention in which two pieces of sausage or cheese should advantageously be cut simultaneously. The holder 1 according to the invention advantageously has two openings 2, 2′ lying side by side to receive two pieces of food. The holder 1 according to the invention is moulded in only one piece, particularly from plastic. The pieces of food must therefore have a substantially constant cross-section over their entire length. The openings 2, 2′ are funnel-shaped (see FIG. 2), so that the sausages or pieces of cheese can be easily introduced. Around the opening 2, 2′, however, the holder 1 is provided in a circle with undercuts 4 through which the resulting tabs 5 press resiliently onto the product to be cut. Depending upon the required contact pressure the undercuts 4 either do or do not have a connection to the opening 2, 2′. Thus, slight unevennesses of the food product can be compensated for and a uniform contact pressure is maintained on the food product.

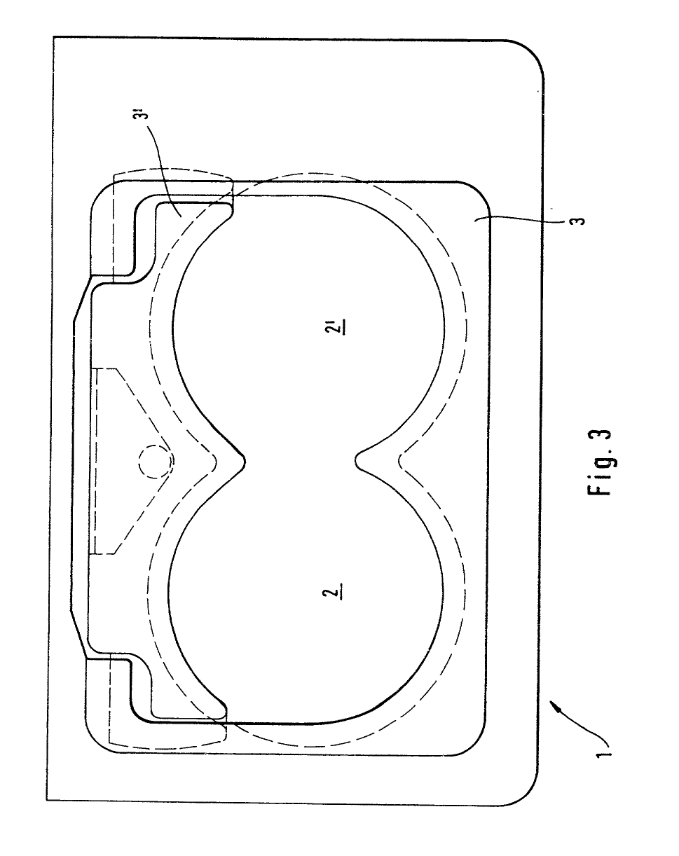

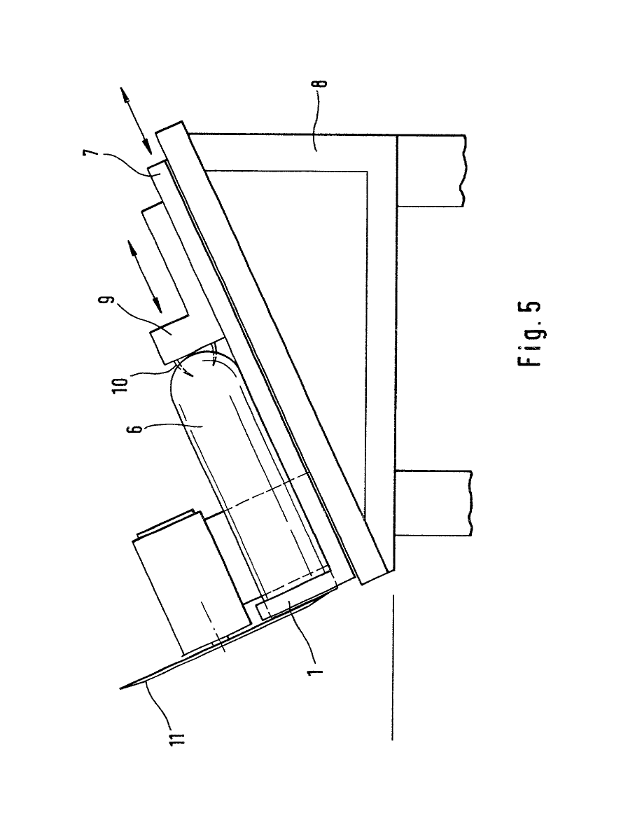

The holder 1 for foodstuff illustrated in FIG. 3 consists in particular of two jaws 3, 3′ which receive the foodstuff between them. However, more jaws can be provided, which make it possible to distribute the contact pressure evenly over the food product. The jaws 3, 3′ act resiliently on the product to be cut, and thus it is easily possible to push the product to be cut further in the direction of the cutting plane but it is nevertheless sufficiently held in shape. The necessary pressing force for the jaws 3, 3′ can be caused by a resilient pressing device or by a pressure cylinder. This construction of a holder 1 makes it possible also to hold foodstuff with an irregular outer contour, such as bacon, ham or meat. In FIG. 4 the holder according to FIG. 3 is shown in a sectional side view.

FIG. 5 shows a diagrammatic representation of the cutting machine according to the invention. The sausage 6 which is to be cut up in this case lies on a product guide 7 which is inclined with respect to the horizontal plane. The guide 7 for the product to be cut is movably disposed on the machine frame 8. A further slide 9 is provided on the product guide 7 and has a claw 10 for holding the food product 6. This slide 9 is also movable relative to the product guide 7 in the axial direction of the product 6 to be cut. In the plane of the product to be cut the sausage 6 is guided by the holder 1 according to the invention which is connected to the guide 7 for the product to be cut. The cutting blade which is intended to cut the sausage 6 into slices of uniform thickness is denoted by 11. Under its own weight the guide 7 for the product to be cut together with the foodstuff 6 is pushed against the cutting blade 11. In order to generate idle strokes the guide for the product to be cut is retracted together with the holder 1 from the cutting plane, so that the food product 6 is still kept in shape by the holder 1. In order to avoid deflection of the foodstuff 6 in the axial direction, the slide 9 can carry out a further retracting movement in addition to the retracting movement of the guide 7 for the product to be cut, so that the food product 6 is relieved of the pressure in the axial direction.

The holders 1 which have been described are very suitable for cutting machines in which during the idle strokes in order to avoid the formation of slivers the product to be cut is retracted together with the holder from the cutting plane. However, it is also conceivable to draw the cutting blade away from the cutting plane whilst maintaining the position of the product to be cut and of the holder. However, this arrangement is not discussed in further detail in the present application.

Although the invention has been described in terms of specific embodiments which are set forth in considerable detail, it should be understood that this is by way of illustration only and that the invention is not necessarily limited thereto, since alternative embodiments and operating techniques will become apparent to those skilled in the art in view of the disclosure. Accordingly, modifications are contemplated which can be made without departing from the spirit of the described invention.

1. Cutting machine for cutting up foodstuffs, said machine comprising
(a) a base frame;
(b) a cutting head disposed on said base frame and including a blade;
(c) a product delivery unit with a guide for product to be cut; and
(d) a feed arrangement;
wherein cutting machine for cutting up foodstuffs, particularly sausage, ham, bacon, meat, cheese and the like, with a cutting head disposed on a base frame as well as a product delivery unit with a guide for the product to be cut and a feed arrangement, wherein at the cutting end of the product to be cut a holder is provided which fixes and shapes the foodstuff and which can be retracted from the blade with the guide for the product to be cut in order to prevent the formation of slivers with idle strokes.

2. Cutting machine as claimed in claim 1, wherein said holder is moulded in one piece from plastics material.

3. Cutting machine as claimed in claim 1, wherein said holder consists of at least two jaws which act on the product to be cut.

4. Cutting machine as claimed in claim 1, wherein said holder has at least one funnel-shaped opening to receive the product to be cut.

5. Cutting machine as claimed in claim 1, wherein said holder has two openings disposed side by side to receive the product to be cut.

6. Cutting machine as claimed in claim 1, wherein said holder is flexible in parts.

7. Cutting machine as claimed in claim 1, wherein said holder is provided, in the region at which it contacts the product to be cut, with undercuts which confer resilience upon that region so that the product to be cut is held by clamping.

8. Cutting machine as claimed in claim 7, wherein said undercuts have a connection to openings in the holder.

9. Cutting machine as claimed in claim 7, wherein said undercuts are closed towards an opening in the holder.
